(19) United States
(12) Patent Application Publication
(10) Pub. No.: US 2011/0176000 A1
(43) Pub. Date: Jul. 21, 2011

(54) System and Method for Counting People

(75) Inventors: Scott Budge, Logan, UT (US); John Sallay, Fairfax, VA (US)

(73) Assignee: Utah State University, North Logan, UT (US)

(21) Appl. No.: 13/010,433

(22) Filed: Jan. 20, 2011

Related U.S. Application Data
(60) Provisional application No. 61/296,924, filed on Jan. 21, 2010.

(51) Int. Cl. H04N 7/16

(52) U.S. Cl. 348/143; 348/E07.054

(57) ABSTRACT

A 3D camera system monitors people passing through a portal. Time sequence data are collected and analyzed. People are counted as they move through the portal and specific people entering the portal are matched with those exiting the portal. Movement is tracked to establish entrance or exit. Features specific to an individual are established and entered into a local data pool to match a person entering with a person later exiting a vehicle or other controlled area. The matching process uses multiple measurements and allows decisions to be made using previous and future information.

### RELATED APPLICATIONS

This application claims the benefit under 35 U.S.C. §119(e) of U.S. Provisional Patent Application No. 61/296,924, filed Jan. 21, 2009, and titled “Sensors and Signal Processing for High Accuracy Passenger Counting” which is incorporated herein by reference.

### TECHNICAL FIELD

The present invention relates to monitoring the passage of people through a portal.

### BACKGROUND

It is imperative for a transit system to track statistics about their ridership in order to plan public transportation routes. There exists a wide variety of methods for obtaining these statistics that range from relying on the driver to count people to utilizing cameras and sensors. A high accuracy people counter using a texel camera is disclosed. A texel image is an image that combines depth information with image data. The technology has two main objectives. The first is a system that accurately counts the number of people entering and exiting a portal or, for example, a public transportation vehicle. The second is to associate each exiting passenger with a passenger that previously entered. This information will, for example, allow a transit system to track usage of vehicles and stops.

A digital camera receives incoming light and describes a scene with color information. It is a simple task for a human being to separate objects in a digital image, but it can be quite a difficult task for a computer to undertake, especially when the objects might be overlapping or of the same color.

A Light Detection and Ranging (LIDAR) sensor measures the time it takes for a pulse of light to travel from the LIDAR sensor, reflect from an object, and return to the sensor. Using this information it determines the distance of objects from the LIDAR. LIDAR is commonly used in mapping ground geography, target identification, and obstacle avoidance. If the LIDAR is capable of measuring the distance from several locations in the scene with a single pulse, the LIDAR is called a flash LIDAR and the result is a depth image of the scene.

Oftentimes it is quite difficult to separate people from each other or background objects in a color image, but the depth information produced from the flash LIDAR provides critical information to the task. As a person enters a scene there is a significant change in the depth information that the LIDAR receives from the background and the person with each snap shot. It then introduces the task to separate the person from the background.

A texel camera is the combination of a flash LIDAR with a digital camera, producing both depth and color information from a single snapshot. The two cameras are mounted together. Incoming light is intercepted by a cold mirror which allows the infrared light pulse transmitted from the LIDAR to pass through to the LIDAR sensor on its return from the scene, and reflects visible light from the same field of view to the digital camera. In this way both cameras receive light from the same field of view. The texel camera fuses the depth information spatially with the color information, producing a 3-D representation of a scene.

Texel technology provides several advantages over other possible technologies that could be used in people counters. First, background separation is more effective as described above. Second, it can perform better than light intensity-based systems when the lighting on a portal varies throughout the day. Shadows, weather, and bright lights are common situations that a people counter would encounter. A light intensity-based imager might not perform well through these changing circumstances, as compared to a LIDAR system. Specifically the LIDAR transmitter is made up of an array of monochromatic modulated LED sources and the receiver is primarily sensitive to the LED wavelength. Since the light is in a very narrow band of wavelengths, the LIDAR will not be affected much by changes in overall lighting.

There is more information available in a texel mage than would be available in a digital image. This is especially important for the task of recognizing when a specific passenger enters and leaves the portal. The color information in conjunction with the depth information allows us to better match an exiting passenger to a data base of passengers currently on the vehicle or area of interest. The ability to identify the characteristics of a person will also allow us to distinguish better the difference between a person and a large object the person is carrying such as skis or a duffel bag. In this manner the task of recognizing people re-enforces the task of counting. This will allow a transit system to know where individual passengers get on and off a vehicle which will be very useful in route planning.

### DESCRIPTION OF THE FIGURES

FIG. 1. Shows a schematic representation of the measurement and analysis process.

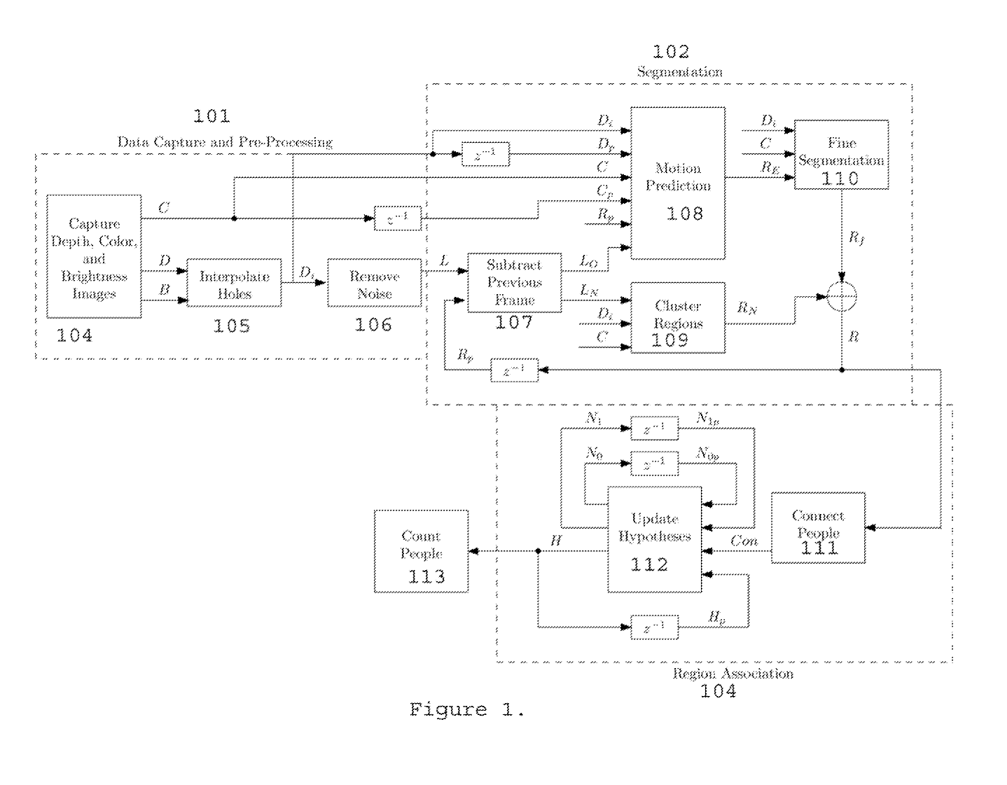

FIG. 2. Shows one embodiment of the functional components of the system.

FIG. 3. Shows another embodiment of the functional components of the system

### DETAILED DESCRIPTION OF THE INVENTION

In one embodiment the 3D camera is mounted above the portal looking down at the floor of the portal. The texel images are therefore acquired from above the people entering and exiting the portal. This allows a consistent view of the people, makes mounting the camera easier, and reduces potential camera damage caused by bumping the camera.

The processing problem can be broken down into three tasks:

1. Track people as they move through a frame.

2. Count people as they enter and exit a portal.

3. Match a person leaving with the same person that previously entered.

Before any of these tasks can be completed, some preliminary steps must be taken. Depth and color images are captured simultaneously 101, 301, 203. Both images will have some distortion due to imperfections in the lenses of the cameras. The distortion is determined through a calibration procedure of the LIDAR camera 206 and a correction is applied in hardware or software. The color image is then mapped to the corrected depth image. The combination of the two is the texel image used.

One step in tracking people is noise and background removal 106. These operations are performed using just the depth image because it is far easier to distinguish the background in a depth image than in a color image. The image is thresholded to remove any bad pixels and background. For example, it is common to have a few noisy pixels with a value larger than the distance to the floor of the portal. Any pixels that are near the distance to the floor of the portal are considered either background or error measurements. These pixels are removed from the image. The image is smoothed using a median filter to fill any small holes created 105 by the thresholding. All of the objects in the image and their sizes are then found. An object is defined as a group of connected pixels. Any object that is too small to be a person is removed from the image. This creates a much cleaner image that only contains the objects that we are interested in tracking.

As people move throughout the image it is necessary to track them. This is a trivial task with single persons in the field of view but it can become quite complicated when there are multiple people in a frame. It also becomes difficult as people enter and exit. One person could exit the frame at the same time that someone else enters.

After noise and background removal 106, the current frame is subtracted from the previous frame to form a difference image 107. If there is very little difference between the two frames then very little motion occurred between the frames. A large difference either means that someone moved significantly or a new person has entered the frame. The location of the movement in the difference image and the direction of travel of the person in the frame distinguish between the two 108. A new person will enter near the edges of the frame while someone in the image from one frame to the next can't change their direction or speed significantly in one frame time.

Sometimes it may be difficult to distinguish between two people. When two people run into each other it can be very difficult to determine where one person ends and the other begins. A motion prediction algorithm is used in these situations 108. We have chosen to use an algorithm very similar to that used in MPEG video encoding for exploiting motion between frames. We again use the previous and current frames. There is no information about where a new person was before entering the frame thus, any new people are removed and the motion prediction is only performed on those who were in the previous frame.

First, the previous frame is divided into 8×8 pixel blocks and a search window is created in the current frame corresponding to each block. We assume that a block can't move a significant amount between frames. The search window size is determined by the amount of motion that would be reasonable to occur, and its location is determined by predicting where the block would move given the velocity of the block in the previous frame.

Each block is shifted to every offset (s, t) in the corresponding search window and the match errors found according to

e(s,t)=Σᵢ₌₁^{N}Σⱼ₌₁^{N}|cp(i+s,j+t)−pp(i,j) (1)

for both the depth and the color pixels, where pp(i, j) is a pixel from the previous image, and cp(i+s, j+t) is a pixel from within the search window in the current image. The value of (s, t) that minimizes the error is used for the motion vector for that block. The velocity of a person is then calculated by taking the average of all the motion vectors of the blocks associated with that person.

There may be some pixels that aren't associated with the previous frame. As a person enters only half of their body may be in one frame and their whole body in the next. The back half of the person isn't in the first frame and thus won't have any motion vectors associated with it. The pixels with no associated motion vectors are assigned to a person based upon the values of the neighboring pixels. In this manner every pixel in the current image is mapped to a person or background from the previous frame.

This algorithm compares the current frame and the previous frame so that a person can be tracked from frame to frame. The segmentation 102 is good enough to track the motion of persons in the images. The performance of the algorithm when one person passes another in the frame may be that the persons represented by the blobs touch each other in passing, but remain distinct.

When a person enters and exits a frame, the side they enter from is recorded. If they start in the top half of a frame they are considered entering the portal. If they start in the bottom half they are exiting the portal. When a person exits the frame, the two sides are compared. A person could get half way in to the portal and then walk back out. They should not be counted in this situation. If the two sides are different, the person will be counted. Depending on the direction of travel, the count of people entering the portal will be incremented or decremented.

There exist many ways to perform this association. One method that is commonly used is known as matched filtering. A template of a person's image is created when they enter and stored in a bank of templates for everyone entering the portal. When a person exits they are compared to every template in the bank. The best match is chosen and removed. The disadvantage of using a matched filter is that the template does not perform well under rotational changes. It would not be uncommon for a person to enter and exit at a different angle. It would also require a lot of storage and computations to match a person's image template.

The solution chosen is similar but with some important distinctions. The following features may be collected for a person who enters the portal:

1. Height

2. Hair Color

3. Hair texture

4. Shoulder height

5. Shoulder color

6. Shoulder texture

If a person rotates, these features should remain approximately invariant. Features are collected for every frame that a person is in the field of view of the camera. As soon as the person exits the field of view of the camera, the features are averaged together to reduce noise in the measurements. If the person is entering the portal, the features are used to construct a “feature vector” and the vectors added to a feature bank. If the person is exiting the portal the feature vectors compared to all of the other vectors in the feature bank and the distance to each stored vector is computed. By using feature vectors, identifying information is still collected, but it requires less memory and fewer computations to match a person.

The distance is found by using the Euclidean distance between the features, given by:

d_{i,j}=\sqrt{Σₖ₌₁ⁿ[Fᵢ(k)−Fⱼ(k)]₂} (2)

where Fᵢ is the feature vector for the exiting person, Fⱼ is the feature vector corresponding to the j^{th} person in the feature bank, n is the total number of features, and Fⱼ(k) is the value of the k^{th} feature for the j^{th} person. The vector Fₘ that produces the smallest distance is considered the best match and is removed from the feature bank.

At this point many useful statistics can be gathered. The simplest and most important is the count of how many people used the portal. The number of people who entered and exited at each stop can also be counted 113. Since we also know who entered or exited the portal we can determine the length of time each person was on the area of interest.

Test data was collected to analyze the accuracy of our algorithm. Data was collected on a portal over a period of several months. Several scenarios were tested. These include:

1. Persons entering quickly

2. Persons entering in bright sunlight

3. People running into each other

4. People entering together (i.e. arm around each other)

The system works very well when people enter quickly. We were able to achieve 95% accuracy with 21 entrances and exits. Direct sunlight did not have any effect on our data and we achieved a counting accuracy of 100% correct. Collisions did not cause a significant counting problem. The motion prediction algorithm described was able to separate the different people very well and we correctly counted in 89% of the cases tested. The greatest difficulty occurs when people enter together. Our system is not currently able to distinguish between them well and we were not able to count correctly in any of these situations. Most of the missed counts are due to this issue. The rest of the data collected did not fit into any of these situations and we achieved a counting accuracy of 99%. This produces an overall counting accuracy of 92% correct.

The difficulty with counting people who enter together is more of a hardware limitation than an algorithm limitation. The resolution of the LIDAR camera 206 we are currently using is about half of that of newer cameras, resulting in a reduced ability to distinguish the depth changes between people. In addition, the depth and digital images also are not taken at exactly the same time due to software triggering. When there is a significant amount of motion between frames there can be large errors in registration between the digital 207 and the LIDAR 206 images. It is difficult to distinguish between people when the images are not aligned in time. Both of these problems could be reduced with a higher resolution depth camera and hardware triggering for frame capture.

Matching accuracy is difficult to measure. The order in which people leave can greatly affect the results. For example, a matching error causes an incorrect person to be removed from the feature bank. When that person leaves another error will occur because their set of features is no longer in the feature bank. We therefore attempted to understand the matching performance of the system using Monte Carlo analysis.

The matching performance of the system was estimated using a database of 33 individuals. Feature vectors were gathered for each of those 37 people as they entered the portal. A subset was selected at random to simulate a set of people. A single person in the set was randomly selected as the person exiting and a feature vector for this person “the exiting vector” was created from data obtained during an exit. Note that this is a different vector than was created for the database of entering persons. Next, the matching algorithm was performed which compared the exiting vector to the subset. The experiment was repeated 10,000 times and the percentage of correct matches was computed. The accuracy decreases with the aggregate number of people entering the portal.

One embodiment of the data acquisition uses a 3D camera system that gathers three images at a time: depth, brightness, and color 203, 301. The depth and brightness images come from a LIDAR camera 206 while the color image comes from a color camera 207. The LIDAR camera has a sensor array of 64×64 pixels. Minimum and maximum brightness thresholds are used. Any brightness value falling below or above these thresholds causes the corresponding value in the depth image to be set to 0. The pixels remain unchanged in the brightness image. The color image is similar to what would be found in a normal digital camera. It outputs three channels of color: red, green, and blue. The color camera has a sensor array of 1280×1024 pixels.

The two cameras capture data from the same scene 104; however, the field of view (FOV) of the two cameras may not be the same. The color camera generally has a much wider FOV. The FOVs of the two cameras are matched together via a calibration process 101. The size of the resulting color image is one of the parameters of the calibration. For this embodiment an image of 256×256 pixels was chosen. This provides color at a higher resolution than the depth image, but it not so large so as to be computationally prohibitive.

In one embodiment the camera system is mounted in the doorway of a 2007 Gillig ski bus. This style of bus does not have any steps at any of the entrances. The distance from the floor to the highest portion of the ceiling is 96 inches. The camera system would be mounted at this height in the portal, near the middle of the ceiling. If the camera were mounted near the door, then a person's depth would change as they stepped onto the portal, which would complicate the problem to be solved.

In one embodiment the system would process the data as it was captured. It need not be processed in real time if there is time in between acquisitions that can be used for processing, for example on application to passengers entering and exiting a bus or train. It would preferably finish processing all of the data from an acquisition before the next acquisition occurs. For example, from one bus stop to the next bus stop.

Background and noise removal 106 is performed for the texel camera. Only the depth image is considered at this stage in the processing. The first step is to median filter the interpolated depth image. This removes noise and smoothes the image. Next, a depth threshold is applied to any pixel that falls outside a reasonable depth range. Upper and lower depth thresholds are set. Any pixel with a depth value falling above or below these thresholds is set to 0. The remaining pixels are grouped together using a recursive labeling technique.

The size of each region in the resulting label image, L, is found, and a size threshold is used to eliminate small regions. The size of a region is dependent on how far away from the camera it is. An object will appear much larger in an image when it is near the camera than when it is far away. Thus, the mean depth value is incorporated into the size threshold as minSizei=T/di where T is the depth threshold, di is the average depth value of the ith region, and minSizei is the size threshold for the ith region. Any region smaller than the size threshold is considered background, and every pixel in the label image that corresponds to this region is set to 0. This prevents small objects from cluttering the scene. The depth image is not changed; however, L is used as a mask whenever the depth image is used.

Previous frame subtraction is a technique for detecting motion in an image 107. When little motion occurs from one frame to the next, the difference between the two frames is small. When there is a significant amount of motion between frames, the difference is large. A person moving quickly through the frame can pass from one end of the frame to another in about 0.5 seconds. This corresponds to about 10-15 frames. A person can reasonably move through about 1/10 of the frame from frame to frame.

The label image, L, from and a region label image Rp are used to create difference images. Previous frame subtraction is used to detect when a person enters the frame. At a sufficient image capture rate, the amount of motion between frames will be small as a person moves through the camera's field of view. A large difference will occur when a new person enters the scene. Size threshold is used on the differenced image. A small region will correspond to a moving person. If the size of the new region is below the size threshold, and it is bordering one of the regions from the previous frame, then all of the pixels in the new region are assigned to the previous region. Two label images are the output of this stage in the process: the existing person label image, LE, which contains all of the regions that were contained in the previous image, and the new person label image, LN, which contains all of the new regions.

Block motion prediction is performed 108. Previous label, depth, and color images are used. The color image may be used at its full resolution of 256×256 pixels or down-sampled to be the same size as the depth image, 64×64 pixels. The previous label image is broken up into blocks of 8×8 pixels. A region label is assigned to each block by the majority label of the pixels inside the block. For each block in the previous image, a search window of 17×13 pixels is created in the new image. The block is shifted through every possible position in the search window and the best shift is found. The best shift is defined as the one that minimizes the shift error. I is an image formed by stacking the depth image, Di, on top of the color image, C. The image, I, is then masked by LE. The image Ip is formed in the same manner using the previous depth, color images, and region label images, Dp, Cp, and Rp. The variable t indexes the layer of the stacked image. The end result is that each region that was present in the previous frame is mapped to some location in the current frame.

It is important to note that head and shoulders are tracked separately. Not only are the head and shoulders different in height and color, they also move differently. Separating the two makes it much easier to track multiple people when they run into each other. There may be pixels in the current frame that are not assigned to any region during this process. In order to assign the leftover pixels, the average depth and color values are found for each region. Each pixel that was not previously assigned to a region is now assigned to the region that it is closest to in depth and color.

Fine Segmentation 110 is a process that cleans up some of the artifacts from motion segmentation. If more motion occurs than can be predicted by the search window, some regions of an image may have blotches that are in error. This may be an artifact of the low capture rate used. This operation may not be necessary for faster camera systems or systems with more resolution. The process uses the average depth and color values for each region in RE. Each pixel in the label image is assigned to the region that it is closest to in depth and color. There may still be some pixels that are not correctly associated. The process removes any subregion that falls below a size threshold. This produces the finely segmented region label image, Rf.

Clustering is performed for two reasons 109. The first is to segment people when multiple people enter at the same time. The second is to segment the head and shoulders of the people who enter a scene. There is no previous motion information for LN that can be used to segment people when they first enter a scene, thus clustering techniques are employed. One algorithm used is k-means clustering. The algorithm divides the data into k regions of minimum variance. The input images are turned into vectors with each one representing a different pixel location. Each vector contains the depth, color, and image coordinates of its respective pixel. The image coordinates are included so that the clustered regions are more likely to maintain spatial connectivity.

One common issue with k-means clustering is that the number of clusters must be known a priori. A common approach is start with k=2 and increment k until a good solution is found. A size threshold is used just as in other parts of the algorithm. Thus k is increased until a region falls below the size threshold. When k is too large, a person's shoulders may be split into two regions, not because the variance inside the region is large, but because the algorithm dictates that there must be k regions. The output of this clustering is region label image, RN. The label image, LN, divides the image into groups by pixel connectivity. The region label image, RN divides the image into different regions based upon height, color, and connectivity. The different regions correspond to the heads and shoulders of the people in an image.

The process can be viewed as:

1. Choose k centroid locations
2. Assign each vi to the region with the nearest centroid
3. Compute updated centroid location for each region
4. If termination condition is not met, return to (2)

All of the regions in an image are tracked separately. Which is to say that a person's head and shoulders are not associated with each other until a person exits. This allows the algorithm time to correct association errors that could occur. For example, two people could start off very close together, and their head regions may be confused. As they move throughout the image, it may become clear which head region belongs to which person. It is also common for a person's shoulders to enter the scene before the head. It is not possible to make a correct association until both regions have entered the camera's field of view. Height and connectivity are used to associate head to shoulders. In each frame, the average height is found for each region and the number of adjacent pixels is found for each pair of regions. In order for two regions to be considered a possible head and shoulder pair, the regions must be connected. The height difference between the regions also must fall within a reasonable range. Anthropometric data may be used for the ratio of total height to head to shoulder distance to assess a reasonable range.

For each pair of regions in R, a normalized ratio, x, is found. A ad hoc fuzzy probability, p(x), is assigned to each pair. This function can be used to produce an upper-triangular connectivity matrix, Con, where the (i, j) entry contains the fuzzy probability that regions i and j are connected.

Possible head to shoulder associations 103 are made for each frame and stored in Con. A hypothesis is also created for each pair of regions. The hypotheses are stored in an upper-triangular matrix, H. They are found by combining the information in Con with information from the previous frames. This information is thresholded to produce the final hypothesis: for example, any value greater than 0.5 is considered a head to shoulder match. A weighted average combination may be used. The weight of the new information would be determined by the number of frames the regions had been present in the image. For example, if a region had been in the field of view for 9 frames, then the weight corresponding to the previous hypothesis would be 0.9 and the weight corresponding to the entry of Con would be 0.1. The problem with this is that the value is largely determined by the first few frames. The weight of each successive update becomes smaller and smaller. If an incorrect association is made, it becomes increasingly difficult to change the hypothesis with each frame.

An ad hoc method can be used that is based on observation. Values of Con that are close to 0.5 cause most of the errors. The predicted associations are usually correct. It is common to have one or two frames for each person where an incorrect association occurs. If the original guess for two regions is in error, there may be any number of frames before information needed to make a correct association is available. A threshold, t, is used to classify each entry in Con as good or poor. Any association with a value within the threshold of 0 or 1 is considered good. Any other value is considered poor. The threshold was chosen to be t=0.2. That is to say that a good match would have a fuzzy probability between [0, 0.2] or [0.8, 1]. Two upper-triangular matrices, N0 and N1, store the number of good 0's and good 1's for each pair of regions. These matrices are updated using their previous values, N0p and N1p, and the thresholded values of Con.

The predicted associations either support or refute the previous hypothesis, which is stored in Hp. If the association supports the hypothesis, then the update for the (i, j) entry is the mean of Con(i, j) and Hp(i, j). If it refutes the hypothesis, Hp(i, j) is decremented (or incremented) toward 0.5. The amount of the decrement (or increment) is determined by the number of good 1's and 0's. If the current hypothesis states that the two regions are connected, then only the number of good 0's is used. The decrement is a fixed number, chosen to be δ=0.1, times the number of good 0's. Lastly, when an updated hypothesis 112 changes from a 1 to a 0 the number of good 1's is set to 0 and vice versa. This prevents the decrement or increment from becoming too large.

Association errors are relatively rare. The method performs well and is able to correct errors on the data collected. One of the reasons that a method such as this is necessary is because of the low capture rate of the system. A less ad hoc algorithm could be used if more frames were available per person.

Counting 113 is usually accomplished once all of the other steps of the process have been completed. When a region leaves the camera's field of view, hard decisions are made concerning region associations. The system waits until all of the regions associated with a person have left the scene to proceed. Once all of the regions are no longer in the field of view a count is made. The direction of travel determines whether the count of people is incremented or decremented.

In order to correctly associate people, identifying information is collected. Features are collected for every region in a frame. Each person is divided into head and shoulder regions in each frame. This provides a natural division of features. All of the features that are calculated for a head are also calculated for the shoulders. A feature vector is created by stacking all of the features associated with a person into a vector. In the following discussion features will be referred to as belonging a region. This region could be either a head or a shoulder. When a person exits, regions are associated as that person's head and shoulder. At that time the distinction will be made and the feature vectors created, using data from both the head and shoulder regions. The features collected can be broken down into three categories: depth features, color features, and texture features. The depth features used are head and shoulder height. The color features used are found in the HSI (Hue, Saturation, and Intensity) color system. The reason for this is that the intensity of a scene can vary greatly from when a person enters to when they exit. For example, a person may enter in direct sunlight and then leave in a shadow. The hue and saturation should not change significantly with the lighting changes. However, the intensity values will vary greatly. Thus, only hue and saturation are tracked for each region. The height and color values stored as features are the respective mean values for the region.

The last set of features deal with image texture. Texture is only collected on the color image. The depth measurements from a person should be approximately smooth with a small curvature. Height texture doesn't make sense because a region's height should be smooth. Thus, a measurement of texture in the depth image would be a better characterization of the measurement noise in the LIDAR than height variations from person to person. Color textures, on the other hand, can vary significantly between people. A person wearing a hat should have significantly different texture in the head region than a person with wavy brown hair. There exist several different measurements of texture in an image. Texture features may include height, hue, hue standard deviation, hue contrast, hue homogeneity, saturation, saturation standard deviation, saturation contrast, saturation homogeneity. It is important to note that all of these features, except for the standard deviation, are found using a co-occurrence matrix, Pd, and not on the original image.

Each of the texture features are found on both hue and saturation. There are 6 in total which provide for 12 features using the two color channels. When this is added to the original height and color features it brings the total number of features to 15 per region, or 30 per person.

A co-occurrence matrix, G, contains pixel frequency counts, like a one dimensional histogram, but it also contains spatial information. A co-occurrence matrix tells how many times a certain pixel combination occurs at a given separation. The (i, j) output value of the co-occurrence matrix is found by summing the number of times that a pixel with value j is a certain distance away from a pixel with value i, at a given orientation. The separation and orientation of pixels to be considered should be selected before calculating the co-occurrence matrix.

The (i, j) entry of G is interpreted as, there are G(i, j) pixels in I that have a pixel value of i, and whose right neighbor has a pixel value of j. For example, G(2, 0)=1. This value can be easily verified by checking for the (i, j) values in I, I(4, 3)=2 and I(4, 4)=0. This is only occurrence of this set of pixels in the image, with this orientation. (I(3, 4)=2 and I(4, 4)=0, although these correspond to the correct values of (i, j), the second pixel is below the first, not to the right.) A different co-occurrence matrix could be found by changing either the separation to more than one pixel or the orientation. It is also important to note that wrap around does not occur. In this example, I(1, 4) does not have a right neighbor; thus, no value can be added to the co-occurrence matrix at this point. The co-occurrence matrix provides a lot of information about texture. Smooth images will have a nearly diagonal co-occurrence matrix, while highly textured images will have the co-occurrence values spread out.

A large number of features are collected for each person. The task now is to decide which of these features are best for classification purposes. This can be difficult to do because the features collected may be correlated with each other. Two features may not be able to classify well by themselves, but together, they may achieve very good classification. On the other hand, a feature may be able to classify well, as long as it is not paired with a certain other feature. Some features may have no effect on classification. It is desirable to only calculate and use the best features for classification. The optimal solution is to try every possible set of features with a given classification technique, and choose the one that classifies correctly most often. With every set of features a simulation can be performed, which can take a significant amount of time. In most cases the number of combinations and the time required is far too large to perform an exhaustive search.

Another approach is adding one feature at a time. Start with an initially empty set of features to consider. Analyze each feature, one at a time, by performing a simulation. Choose to keep the feature that is most accurate in the simulation. Repeat the process, analyzing the best feature from before with one other feature added. The process is repeated either a set number of times or until accuracy ceases to improve from adding another feature. This is known as sequential forward selection.

A similar sequential backward selection process exits. The process starts by considering all of the available features at the same time. One feature is removed, and a simulation is performed. This is repeated on all features, and the worst feature is removed from consideration. The process is repeated until either of the termination conditions is met. Both methods can produce good results, but they can easily get stuck in a local minimum. Once a feature is added (or removed) it may not be later removed from (or added back into) the set of features. A forward-backward algorithm that alleviates this problem but is not guaranteed to find a global minimum. In general, it's able to produce a better result than either the forward or backward algorithms by themselves. Linear Discriminate Analysis (LDA) is another technique that may be used.

The classification performed falls into the category of supervised learning. When a person enters a portal, a set of feature vectors is collected. These features are used to make a classifier for the person. When a person leaves a portal, another set of feature vectors is collected. This set is compared to all of the classifiers that currently exist and the best match is found. A wide variety of classification techniques exists. Three examples are: Linear Discriminate Analysis (LDA), Quadratic Discriminate Analysis (QDA), and K-Nearest Neighbor (KNN).

Normally, one measurement is classified at a time. In this particular case, several measurements are collected as a person walks underneath the camera, and then the measurements are combined together. The aforementioned classification techniques may be used to account for classification using multiple measurements known to be from the same class.

Linear discriminate analysis is a method used in statistics, pattern recognition and machine learning to find a linear combination of features which characterize or separate two or more classes of objects or events. The resulting combination may be used as a linear classifier, or, more commonly, for dimensionality reduction before later classification. In LDA, it is assumed that all measurements are independent draws from a set of Gaussian distributions with different means. In the context of the problem at hand, each class corresponds to a distinct individual in a group. It is further assumed that all of the Gaussian distributions have the same covariance matrix. LDA can be extended to exploit multiple measurements. QDA makes the same assumptions as LDA, except that it does not assume that each of the classes have a common covariance matrix. Thus, a covariance matrix needs to be computed and stored for each class.

In KNN, feature vectors are classified according to the vectors from the training set that they are closest to. In the case of counting people, features are stored for each person as they enter the portal. An exiting vector falls into one decision region, and is assigned the same label as that region. The K in K-Nearest Neighbor is the number of points to be considered in creating the Voronoi regions. If some of the K points belong to different classes, then the region corresponds to the class that the majority of the K points belong to. As an example, assume K=5. At a given point, three of the nearest training vectors may belong to class 1, while the remaining two nearest training vectors belong to class 2. The vector is assigned to class 1 because there were more neighbors in class 1 than in class 2. In practice, the Voronoi regions do not need to be calculated explicitly. All of the training vectors are stored. The distance between an exiting vector and all of the training vectors is found. The classes of the vectors corresponding to the K smallest distances are found. The exiting vector is assigned to the majority class of the K nearest neighbors. KNN is easily extended to multiple measurements. The K nearest neighbors are found for each of the exiting vectors. For m measurements, K·m neighbors are found. All of the vectors are assigned to the majority class of these K·m nearest neighbors.

In test cases LDA performed significantly better than the other classifiers. The reason for this is the sparsity of data. In QDA each person has 18 features that are tracked in two 9×9 correlation matrices. There is a minimum of 9 measurements needed in order for the matrix to be invertible. In many cases there are fewer than 9 measurements available for a person. A regularizer is used, but it causes significant distortion when there are few measurements. The correlation matrices are not very accurate for some of the people in the set. In KNN a similar problem occurs. Due to the sparsity of data, a measurement may be relatively close to the true mean, but close to

In LDA, the overall covariance matrix is constructed from all of the training measurements. The main cause of variation from the mean value of the features collected is measurement noise. This noise is independent of the person being matched. LDA is able to produce a more stable covariance estimate than QDA by combining all of the data available.

Other classification techniques could be used. For example, there are many distribution matching techniques. These would suffer from the same problems as QDA and KNN. The sparsity of the data would limit the accuracy of such techniques.

Decisions can have a great effect on all of the later decisions to be made. A simple approach is to make a hard decision as soon as a person exits the portal. The person associated with the exiting person is removed from further consideration. In this manner, everyone on the vehicle or area of interest will eventually be assigned to an exiting person. The hard decisions are the only information that is incorporated into the later decisions. Any decision reduces the number of people to be considered at a later time. If the decision is correct, this increases the probability of a correct decision at a later time. However, if the decision is incorrect, the error will propagate through to other decisions. One error can cascade into several.

It may be possible to exploit some of the properties of the data in order to reduce the cascading effects of an error. We describe a few heuristics that make use of previous data in order to make decisions. Ideally, in the sequence estimation problem there would be a one to one mapping of exiting people to people who entered the portal. This one to one mapping is ideal, but there are situations in which it can't occur. The counting method does not achieve 100% accuracy. Thus, it is possible to have a person exit that was never counted as entering the portal and vice versa. If a one to one mapping is assumed, the first case leads to a minimum of two classification errors. As an example, person x exits and is classified as person y. When person y exits, another error must occur. If person y is the last person to exit, then the error will not propagate any further, because there is no one left for the error to propagate to. This problem can continue for far more than two errors.

Error propagation can also occur when the count of people is correct. In this case, the minimum number of errors is two. For example, person x exits and is classified as person y. Only two errors occur if person y is later classified as person x. If person y is not classified as person x, more errors will occur.

In an attempt to mitigate these problems, a one to many mapping of entering people to exiting people is allowed. That is to say that a person is allowed to exit multiple times. If a classification error occurs, it does not necessarily propagate to other decisions; however, it also causes other errors to occur. In an extreme case, a single person could be classified as every exiting person. Only one of these decisions is correct, all of the others constitute errors.

The ad hoc approach assumes that counting and classification errors will occur. It attempts to mitigate their effects via thresholding. Three thresholds are described, however, any discriminate function may be used. The value of the discriminate function is oftentimes much smaller for one person than for every other person considered. This approach assumes that it is appropriate in this situation to make a hard decision without any further processing. A difference threshold, td1, is set and the values of the discriminate function are sorted. If the difference between the smallest and the second smallest values of the discriminate function is above this threshold, a hard decision is made.

There are also situations in which the best match may not be a very good match. For example a person may enter wearing a hat. The hat is subsequently removed before exiting. The features collected for the head, when that person exits, will be very different from the features collected when that person entered. A large measurement error will occur which increases the likelihood of a classification error. A minimum value threshold, tm, is used to mitigate this problem. If the minimum value of the discriminate function used is below this threshold, the match is considered good, a hard decision is made, and the person is removed from further consideration. If the minimum value is above the threshold, a hard decision can still be made, but the person will not be removed from further consideration.

The last heuristic deals with situations in which the value of the discriminate function is similar for multiple people, creating an ambiguous decision. Errors often occur in this situation. Another difference threshold, td2, is added to the minimum discriminate value obtained, producing tw=td2+dmin. All of the people for whom the value of the discriminate function falls below tw are put into a waiting pool. Decisions are not made until more information is known. Whenever a hard decision is made, the waiting pool is checked. If the person for whom the hard decision was made is in the waiting pool, they are removed. At this point, it may be possible to make further decisions, since the source of the ambiguity may have been resolved. This decision will cascade through the waiting pool until no further decisions can be made. It may not be possible to eliminate everyone from the waiting pool in this manner.

Each entry in the waiting pool is comprised of a possible entering person, pi, a possible exiting person, ei, and a distance, di. These three values are known collectively as an edge. All of the edges in the waiting pool can be grouped into three vectors: a vector of entering people, p, a vector of exiting people, e, and a vector of distances, d. A given person may appear several times in p or e. When a person exits, there may be ambiguity of multiple people who could have left. The ambiguity can also be viewed in another light. For each person in the pool, there may be several exits at which that specific person may have exited. The waiting pool reduction process attempts to resolve both ambiguities. All of the distances associated with a given person, person i, in p are put in the vector di. This represents the distances for all of the stops that person i may have exited. The difference between the maximum and minimum values of di is computed for each distinct person in p. If the difference is small, a significant ambiguity exists. However, if the difference is large, the ambiguity can be resolved more easily. This difference is stored in the dist1 vector for each distinct person in p. The same process is repeated for every distinct person in e, and the differences are stored in the dist2 vector. In this case, all of the values in dj represent the distances associated with all of the people who may have been the jth person to exit the portal. Only one edge is removed at each iteration. The edge associated with the maximum value of dist1 and dist2 is removed. At this point it may be possible to make hard decisions. If any exiting person now has only person associated with it, then a hard decision is made. This person is removed from further consideration. All edges in the waiting pool involving this person are removed. It is possible that other hard decisions can be made due to this propagation. These decisions are propagated through until no further decisions can be made. The process outputs a matrix of associations, A. The matrix has two rows. Each column represents an association of an entering person to an exiting person.

Another method of performing sequence estimation is in the maximum likelihood sense. The probability of a given sequence of n sets of feature vectors is: P(X1=x1,X2=x2, . . . , Xn=xn|G1=k1,G2=k2, . . . , Gn=kn), where (Gi=ki) is the event that the ith person to exit is person ki, and (Xi=xi) is the event that the ith observation is xi. The observation xi is the set of feature vectors collected as the ith person exits, xi={x1i, x2i, . . . , xmi}. In order to simplify equations below, the events (Xi=xi) and (Gi=ki) will be referred to as xi and ki. Each observation, xi, only depends on the class, ki, from which it came. That is to say that each xi is conditional independent given ki.

LDA is used for classification, thus each xi is assumed to be a set of observations from a Gaussian random variable. A solution would be to evaluate this sum for every possible value of k and choose the set that minimizes the sum. This would be prohibitive, even for a relatively small number of people. One method is to use a trellis to search through all of the possible paths. In order to use a trellis, a state is defined as the people in the data set. In terms of the trellis, if multiple paths pass through the same state, the path with a larger cost can be pruned and never considered again. In this manner, the trellis significantly reduces the total number of possible sequences to be explored, without losing optimality. The trellis can also be used to accommodate people entering.

The trellis significantly reduces the number of paths that need to be explored in order to arrive at an optimal solution in the maximum likelihood sense. However, the number of paths can still be prohibitive. The number of states at a given time step depends on the number of people and the number of people that will be considered as a possible match. The number of states to be considered can grow quite large, even for relatively small N. It is not feasible to store or to compute paths for such a large number of states. An approach used in such a situation is a beam search. A beam width, W, is selected. At each stage of the trellis, only the W best paths are stored. At the next stage, extensions are made from these paths, the path costs are sorted, and then the number of extensions is pruned to the W paths of smallest cost. Optimality is sacrificed in order to decrease memory and computational requirements. The number of states to be stored at each time step is constant. At stop t, all of the paths in the trellis are in sorted order. There are Nt people on the vehicle or area of interest at this time. For each person, there is a cost associated with the event of that specific person exiting at time t. These costs are also sorted. Using sorted data reduces the number of extensions that need to be stored. It is not necessary to store the full state at each time step either. The necessary information can be found by only storing the person corresponding to the edge labels. The set of exiting people can be found by back tracing through the trellis. A buffer, Bt, is created which can store W edge labels. The buffer Bt−1 can be used to find the W best states from the previous stage of the trellis. A cost vector, Cp is also used. This vector contains the path costs associated with each of the paths that can be derived from back tracing through Bt−1,Bt−2, . . . , B1. The new path costs will be stored. The path cost of an extension of person j at time t can be calculated. The trellis requires a one to one mapping of entering people to exiting people, a person cannot exit at multiple occurrences. Any extension that would require a person to exit twice will not be made.

The cost vector C is updated with each extension. The extensions naturally appear in sorted order, due to the input data being pre-sorted. Note that any extension that would require a person to exit the portal twice is not stored in the buffer, and thus is not counted as one of the W extensions. It is also possible for two paths to correspond to the same set of people exiting but in different orders. No two paths in Bt will correspond to the same set of people exiting. The process is now repeated, creating extensions. If Bt contains less than W states, the extensions are created as before. If Bt contains W states, an insertion sort is used. An extension is created, and it is first checked to make sure that it does not correspond to the same set of exiting people as any other stored path. If it does not correspond to any other stored path, an insertion sort is used to put the set of extensions in order by cost. The highest cost extension in B will be dropped as the new extension is added. If it does correspond to another stored path, the path with higher cost is removed. An insertion sort is now used to put the lower cost path in the correct location. The costs of the input data are sorted. There is no need to test any further extensions. This process is repeated, creating extensions of all of the elements. The elements are in sorted order after all of the extensions have been made.

The beam search requires a one to one mapping of entering people to exiting people. Also, the accuracy of a beam search is a function of the beam width, W. A wide beam will produce a better approximation of the optimal trellis, but it also increases the amount of computations to be performed. The beam search relies heavily on the order of the exiting people as well. An attempt is made to combine the beam search with the thresholds of the ad hoc technique. It may be possible to reduce the complexity of the beam search without sacrificing accuracy. In the standard beam search, a set of people are considered for possible extensions at time t. The third threshold, tw, is used to limit the number of extensions made. Only the people for whom the associated cost is below tw are used to create extensions. An allowance for a many to one mapping is also made. Back tracing is no longer performed when an extension is added to the trellis, which allows a person to exit at multiple stops.

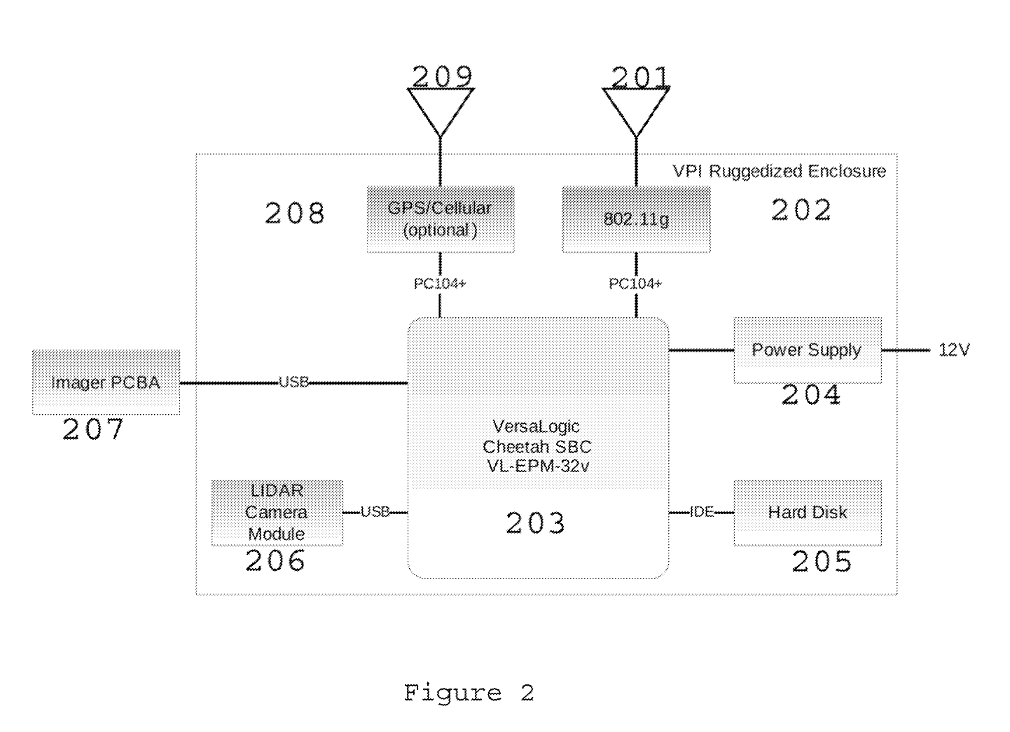

One embodiment of the system design is given in FIG. 2. An imager 207 and LIDAR camera 206 are interfaced via USB to a VersaLogic device 203. Links are made to GPS 208, 209 and an 802.11g interface 202, 201. The unit receives power from a power supply 204 and stores data on a hard disk 205. The system is enclosed in a ruggedized enclosure.

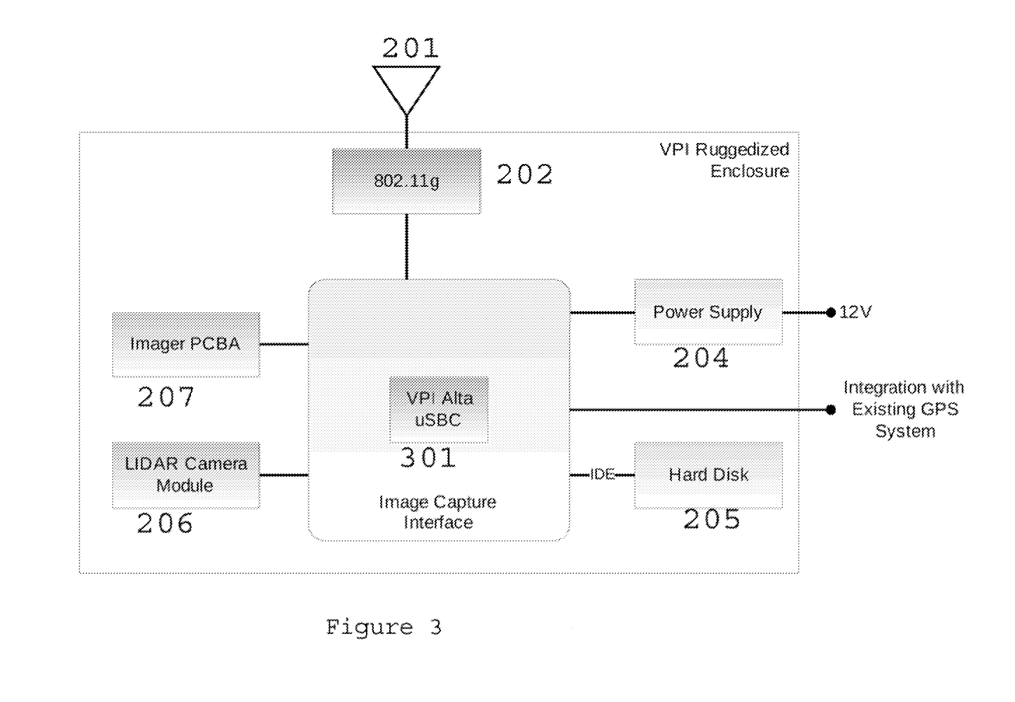

Another embodiment of the system design is given in FIG. 3. An imager 207 and LIDAR camera 206 are interfaced to a VPI Alta Image Capture Interface device 301. Links is made to an 802.11g interface 202, 201. The unit receives power from a power supply 204 and stores data on a hard disk 205. The Interface 301 is integrated with an existing GPS System 302. The system is enclosed in a ruggedized enclosure.

The above description discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

What is claimed is:

1. A system for counting people comprising:
a 3D imaging camera;
a portal;
a data storage device;
a data analysis computer;
said 3D imaging camera configured to provide data to said data storage device;
said data analysis computer configured to access data from said data storage device;
said 3D imaging camera mounted to observe said portal from above; and
wherein said 3D imaging camera generates a data set representing each person passing through said portal.

2. The system of claim 1 wherein:
said data analysis computer identifies and correlates the multiple data sets for a person passing through the portal multiple times.

3. The system of claim 1 wherein:
said data analysis computer removes any bad data and background from said data set.

4. The system of claim 3 wherein:
said data analysis computer applies a median filter to said data set.

5. The system of claim 1 wherein:
said data analysis computer identifies features of persons passing through said portal wherein said features are selected from the set including height, hair color, hair texture, shoulder height, shoulder color, and shoulder texture.

6. The system of claim 5 wherein:
said data is collected over multiple frames while a person in the field of view of the camera.

7. The system of claim 6 wherein:
said features are averaged together to reduce noise in the measurements.

8. The system of claim 5 wherein:
said features are averaged together to reduce noise in the measurements.

9. The system of claim 5 wherein:
said data collected over multiple frames while a person is in the field of view of the camera is analyzed to track said person as they move through a frame.

10. The system of claim 5 wherein:
said data collected over multiple frames while a person is in the field of view of the camera is analyzed to count people as they enter and exit said portal.

11. The system of claim 5 wherein:
said data collected over multiple frames while a person is in the field of view of the camera is analyzed to match a person leaving with the same person that previously entered said portal.

12. A system for counting people comprising:
a 3D imaging camera;
a portal;
a data storage device;
a data analysis computer;
said 3D imaging camera configured to provide data to said data storage device;
said data analysis computer configured to access data from said data storage device;
said 3D imaging camera mounted to observe said portal from above;
said 3D imaging camera produces data of people within said portal;
said data is stored on said data storage device;
said data is collected over multiple temporal frames while a person is in the field of view of the camera; and
said data collected is analyzed to track people as they move through a frame.

13. The system of claim 12 further comprising:
a search window created in a frame of data wherein the search window size is determined by the amount of motion that would be reasonable to occur, and its location is determined by predicting where the block would move given the velocity of the block in the previous frame.

14. The system of claim 13 wherein:
each block is shifted to every offset (s, t) in the corresponding search window and the match errors found according to
e(s,t)=Σᵢ₌₁^{N}Σⱼ₌₁^{N}|cp(i+s,j+t)−pp(i,j)|

where pp(i, j) is a pixel from the previous image, and cp(i+s, j+t) is a pixel from within the search window in the current image.

15. The system of claim 14 wherein:
the value of (s, t) that minimizes the error is used for the motion vector for that block.

16. The system of claim 14 wherein:
the velocity of a person is then calculated by taking the average of all the motion vectors of the blocks associated with that person.

17. The system of claim 6 wherein:
said features are averaged together to reduce noise in the measurements.

18. The system of claim 5 wherein:
said features are averaged together to reduce noise in the measurements.

19. A method for counting people comprising:
acquiring multiple data from a portal using a 3D imaging camera mounted to observe said portal from above;
wherein said 3D imaging camera generates a data set representing each person passing through said portal;
storing said data on a data storage device;
analyzing said data on a computer; and
said computer identifies and correlates the multiple data sets for a person passing through the portal multiple times.

20. The method of claim 19 wherein:
said data collected over multiple frames while a person is in the field of view of said camera is analyzed to track said person as they move through a frame.

21. The method of claim 19 further comprising:
analyzing said data to count people as they enter and exit said portal.

22. The system of claim 19 further comprising:
Analyzing said data to match a person leaving with the same person that previously entered said portal.
